(19) United States
(12) Patent Application Publication
(10) Pub. No.: US 2012/0200178 A1
(43) Pub. Date: Aug. 9, 2012

(54) LINEAR MOTOR ACTUATOR

(75) Inventor: Yoshihiro Kimura, Tokyo (JP)

(73) Assignee: THK CO., LTD., Tokyo (JP)

(21) Appl. No.: 13/500,184

(22) PCT Filed: Sep. 8, 2010
(86) PCT No.: PCT/JP2010/065406

§ 371 Date: Apr. 4, 2012

(30) Foreign Application Priority Data
Oct. 7, 2009 (JP) 2009-233019

(51) Int. Cl. H02K 41/02

(52) U.S. Cl. 310/12.31

(57) ABSTRACT

Provided is a linear motor actuator capable of eliminating an influence to be exerted onto linear guides (3) due to heat generated by a coil unit (50), sufficiently securing moving accuracy and positioning accuracy of a table plate (4) supported by the linear guides (3), and in addition, maintaining the accuracies over a long period of time. The linear motor actuator includes: a base plate (2) to be fixed to another mechanical apparatus; a plurality of linear guides (3) disposed parallel to each other on the base plate (2); a table plate (4), which is supported by the plurality of linear guides (3) and freely reciprocates above the base plate (2); a magnet unit (51) provided on the table plate (4); and a coil unit (50) provided on the base plate (2) so as to be opposed to the magnet unit (51) to form a linear motor (5). The base plate (2) and the table plate (4) are each made of a material having a coefficient of linear expansion of 11×10⁻⁶ (1/° C.) or less, and a difference is provided between the coefficients of linear expansion of the base plate (2) and the table plate (4).

### TECHNICAL FIELD

The present invention relates to a linear motor actuator for enabling translational motion of an object to be conveyed mounted on a table plate, to thereby position the object to be conveyed.

### BACKGROUND ART

In a factory automation (FA) apparatus such as an XY table and an article conveying apparatus, a so-called linear motor actuator is heavily used, which linearly moves an article, a member, and the like by a linear motor. This type of linear motor actuator generally includes: a base plate to be fixed to another mechanical apparatus; a table plate onto which a movable member such as an article, which serves as a conveyance target, is mounted and which moves above the base plate; a plurality of linear guides for guiding the table plate so that the table plate linearly reciprocates freely with respect to the base plate; a linear motor for providing a thrust force to the table plate; and a linear encoder for detecting the position of the table plate. Through control of the linear motor in accordance with a detection value of the linear encoder, the table plate is movable by an arbitrary amount with high accuracy (JP 2005-79496 A).

Further, each of the linear guides includes a track rail, and a moving block assembled to the track rail via a large number of balls. In a case where the table plate is supported by the base plate, for example, a pair of linear guides are used, and the track rail of each of the linear guides is laid down on the base plate, whereas the moving block thereof is fixed to the table plate. The moving block is assembled to the track rail via a large number of rolling members, and hence the moving block is in a state of being restrained with respect to the track rail in directions other than the moving direction. Therefore, when such a linear guide is used to support the reciprocating motion of the table plate, it is possible to guide the movable member mounted on the table plate with good accuracy.

Further, the linear motor includes a magnet unit in which north and south magnetic poles are alternately arranged along a moving passage of the table plate, and a coil unit which is arranged opposed to the magnet unit via a small gap, for generating a shifting magnetic field in accordance with supply of a current. One of the magnet unit and the coil unit is disposed on the base plate for use, and the other thereof is disposed on the table plate for use.

The coil unit may be provided to any one of the base plate and the table plate. However, when the coil unit is disposed on the table plate and the magnet unit is disposed on the base plate, the magnetic force of the magnet unit arranged on the base plate acts to the leading end and the trailing end of the opposing table plate, and hence when the table plate moves above the base plate, a variation in thrust force corresponding to the arrangement pitch of the magnetic poles of the magnet unit, that is, a cogging phenomenon is generated. Therefore, there is a problem that it is difficult to smoothly move the table plate, and in particular, the cogging phenomenon is especially prominent in a thin-type linear motor actuator in which the base plate and the table plate are provided close to each other.

Therefore, from the viewpoint of avoiding the generation of the cogging phenomenon as much as possible and enabling smooth movement of the table plate, it is better for the thin-type linear motor actuator to have a structure in which the magnet unit is disposed on the table plate, whereas the coil unit is disposed on the base plate.

Meanwhile, when the linear motor actuator as described above is constructed, the coil unit forming the linear motor generates heat during energization, and hence the heat generated by the coil unit is conducted to the base plate and the table plate, and thus the temperatures of those base plate and table plate tend to increase during operation. Even when the coil unit is disposed on the base plate as described above, during the continuous rated operation of the linear motor actuator, the temperature of the coil unit increases up to about 70 to 90° C. As a result, heat conduction from the coil unit to the table plate occurs due to air convection, and thus the temperature of the table plate, which is not brought into direct contact with the coil unit, also increases. In particular, in the thin-type linear motor actuator in which the base plate and the table plate are provided close to each other, the gap between the table plate and the base plate is extremely small, and hence the temperature of the table plate markedly increases.

Even when the temperature increases in both of the base plate and the table plate due to the heat generated by the coil unit, there is a difference between temperatures at which those plates reach the thermal equilibrium state, and hence the thermal expansion amounts of the base plate and the table plate differ from each other during the continuous rated operation of the linear motor actuator. Therefore, when the plurality of linear guides are disposed parallel to each other to support the table plate, there are problems that the moving block may be displaced with respect to the track rail, the rolling members present between the moving block and the track rail may be excessively compressed, the moving resistance of the table plate with respect to the base plate may unintentionally increase, and further, the linear guide maybe worn at an early stage.

Note that, such problems occur when a material having high rigidity such as iron (for example, SS400) is used for each of the base plate and the table plate, and when a soft material such as aluminum is used therefor, the problems do not occur in a case where those base plate and table plate have a hollow extruded shape. This is because the base plate or the table plate is deformed to substantially reduce the load acting on the rolling members of the linear guide. However, in such a linear motor actuator, there is a problem that the moving accuracy itself of the table plate with respect to the base plate cannot be enhanced.

In Japanese Patent Application Laid-open No. 2005-79496, in order to address the problems caused by the heat generation of the coil unit as described above, there is taken a measure of mounting a radiator plate or a radiator fin to the table plate on which the coil unit is disposed, to thereby suppress temperature increase of the table plate.

### PRIOR ART DOCUMENT

### Patent Literature

Patent Literature 1: JP 2005-79496 A

### DISCLOSURE OF THE INVENTION

### Problems to be Solved by the Invention

However, when active cooling means such as the radiator plate or the radiator fin is provided, the size of the linear motor actuator increases accordingly, which is unsuitable when downsizing or thinning the linear motor actuator. Further, in the linear motor actuator, the coil unit is energized even when the table plate is continuously stopped at a certain position above the base plate or when a thrust force is generated to perform an operation of pressing a workpiece on the table plate against another member, and hence in a usage mode in which the stopping time period of the table plate is longer than the running time period thereof, the cooling means as described above has poor efficacy.

### Means for Solving the Problems

The present invention has been made in view of the above-mentioned problems, and hence has an object to provide a linear motor actuator capable of eliminating an influence to be exerted onto linear guides due to heat generated by a coil unit, sufficiently securing moving accuracy and positioning accuracy of a table plate supported by the linear guides, and in addition, maintaining the accuracies over a long period of time.

Specifically, according to the present invention, there is provided a linear motor actuator, including: a base plate to be fixed to another mechanical apparatus; a plurality of linear guides disposed parallel to each other on the base plate; a table plate, which is supported by the plurality of linear guides and freely reciprocates above the base plate; a magnet unit provided on the table plate; and a coil unit provided on the base plate so as to be opposed to the magnet unit to form a linear motor, in which each of the plurality of linear guides includes: a track rail having a rolling contact surface for a large number of rolling members formed therein along a longitudinal direction thereof; and a moving block assembled to the track rail via the large number of rolling members to move along the track rail. Further, the base plate and the table plate are each made of a material having a coefficient of linear expansion of 11×10⁻⁶ (1/° C.) or less, and a difference is provided between the coefficients of linear expansion of the base plate and the table plate.

### Effects of the Invention

The coefficient of linear expansion of iron (SS400) is about 11.5×10⁻⁶ (1/° C.), and hence when a material having a coefficient of linear expansion of 11×10⁻⁶ (1/° C.) or less is selected for each of the base plate and the table plate, it is possible to suppress the thermal expansion amounts of those base plate and table plate, and a difference between the thermal expansion amounts of both the plates can be reduced.

Further, even when the coil unit is disposed on the base plate, depending on the fixing mode of the base plate with respect to the another mechanical apparatus and the size and material of a movable member to be mounted on the table plate, the temperature of the table plate may be higher than that of the base plate. Therefore, a difference is provided between the coefficients of linear expansion of the base plate and the table plate, to thereby reduce the difference between the thermal expansion amounts of both the plates.

That is, according to the present invention, even when the temperatures of the base plate and the table plate increase to reach the thermal equilibrium state due to the continuous rated operation of the linear motor actuator, the difference between the thermal expansion amounts of both the plates can be reduced as much as possible, and it is possible to sufficiently secure moving accuracy and positioning accuracy of the table plate supported by the linear guides, and in addition, maintain the accuracies over a long period of time.

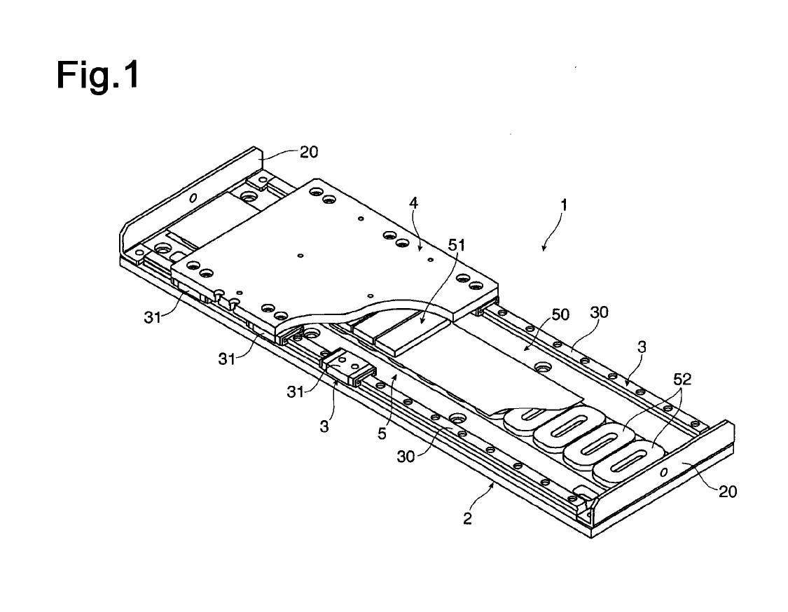

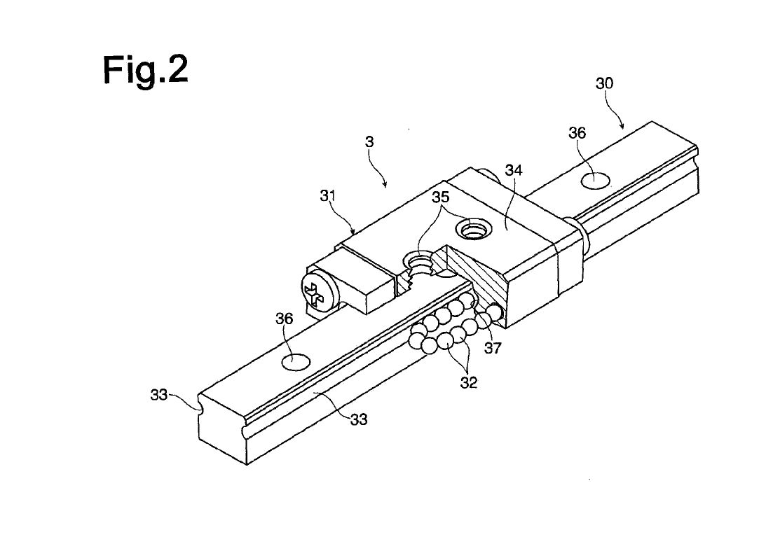

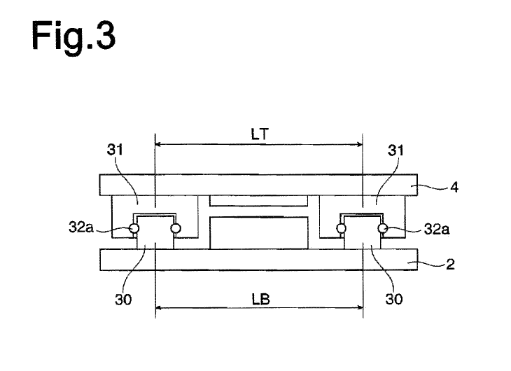

### BRIEF DESCRIPTION OF THE DRAWINGS

[FIG. 1] A perspective view illustrating an embodiment of a linear motor actuator to which the present invention is applied.

[FIG. 2] A perspective view illustrating an example of a linear guide which is usable in the embodiment of FIG. 1.

[FIG. 3] A view illustrating a relationship between a distance between track rails on a base plate and a distance between moving blocks on a table plate.

### MODE FOR CARRYING THE INVENTION

Hereinafter, a linear motor actuator of the present invention is described in detail with reference to the attached drawings.

FIG. 1 is a perspective view illustrating an example of an embodiment of the linear motor actuator to which the present invention is applied. A linear motor actuator 1 includes: a base plate 2 to be fixed to a fixing portion of a casing or a bed of a mechanical apparatus; two linear guides 3 disposed parallel to each other on the base plate 2; a table plate 4 supported by the linear guides 3 and assembled so as to freely linearly-reciprocate above the base plate 2; and a linear motor 5 for propelling the table plate 4 with respect to the base plate 2.

The base plate 2 is formed into a rectangular shape, and the two linear guides 3 are disposed along the long side of the base plate 2. The table plate 4 is provided so as to straddle the two linear guides 3 disposed with an interval therebetween, and a space for disposing the linear motor 5 is provided between the front surface of the base plate 2 and the rear surface of the table plate 4. Further, on the short side of the base plate 2, a stopper plate 20 for preventing overrun of the table plate 4 is provided.

FIG. 2 is a perspective view and a front sectional view illustrating details of the structure of the linear guide 3. The linear guide 3 includes a track rail 30 fixed to the base plate 2, and a moving block 31 which moves along the track rail 30 and is fixed to the table plate 4. The track rail 30 is formed so that a cross section in a direction perpendicular to a longitudinal direction thereof has a substantially rectangular shape, and in one side surface along the longitudinal direction thereof, a rolling contact surface 33 for balls 32, which serve as rolling members, is formed.

The rolling contact surface 33 is formed so that a cross section in a direction perpendicular to a longitudinal direction thereof has a Gothic arch shape, and the ball 32 is brought into contact with the rolling contact surface 33 at two points. Meanwhile, in a side surface of the moving block 31, a load rolling contact surface 37 opposed to the rolling contact surface 33 of the track rail 30 is formed. The large number of balls 32 roll between the rolling contact surface 33 of the track rail 30 and the load rolling contact surface 37 of the moving block 31 while applying load. The load rolling contact surface 37 is also formed so that a cross section in a direction perpendicular to a longitudinal direction thereof has a Gothic arch shape, and the ball 32 is brought into contact with the load rolling contact surface 37 at two points. Further, in the moving block 31, an endless circulation path for circulation of the balls 32 which have been finished rolling on the load rolling contact surface 37 is formed, and the balls 32 are circulated infinitely so that the moving block 31 is movable continuously along the track rail 30.

In the linear guide 3, the moving block 31 is in a state restrained by the track rail 30 via the balls 32, and is freely movable along the track rail 30 while applying load that acts in the direction perpendicular to the longitudinal direction of the track rail 30.

Note that, the moving block 31 is provided with amounting surface 34 for fixing thereto the table plate 4, and the mounting surface 34 is provided with bolt mounting holes 35, into which fixing bolts passing through the table plate 4 are screwed. Further, the track rail 30 is provided with bolt inserting holes 36 arranged at certain intervals in the longitudinal direction thereof, which are used at the time of fixing to the base plate 2.

In the embodiment of the linear motor actuator 1 illustrated in FIG. 1, three moving blocks 31 are assembled to one track rail 30 to form one linear guide 3, and the table plate 4 moves above the base plate 2 while being supported by six moving blocks 31. However, design changes of the number of the linear guides 3 to be disposed on the base plate 2 and the number of the moving blocks 31 to be assembled to one track rail 30 may be made as appropriate depending on the size and weight of the table plate 4 and the load of a movable member to be mounted onto the table plate 4. Further, as the rolling members, rollers may be used instead of the balls.

Further, the linear motor 5 is provided between the base plate 2 and the table plate 4. The linear motor 5 is a synchronous linear motor, and includes a coil unit 50 fixed to the base plate 2, and a magnet unit 51 fixed to the table plate 4. The coil unit 50 and the magnet unit 51 are opposed to each other via a small gap, and the gap is maintained by the function of the linear guides 3.

The coil unit 50 includes a plurality of coil members 52 arranged along the moving direction of the table plate 4. The respective coil members 52 are provided so as to correspond to the U phase, the V phase, and the W phase of the three-phase alternating current, and three coil members 52 form one set to generate a shifting magnetic field during supply of the three-phase alternating current. Meanwhile, the magnet unit 51 includes a plurality of permanent magnets arranged along the moving direction of the table plate 4, and the respective magnets are arranged so that north and south poles are alternately inverted. Therefore, when the respective coil members 52 of the coil unit 50 are energized, the coil unit 50 generates the shifting magnetic field, and based on this shifting magnetic field, a magnetic attractive force or a magnetic repulsion force acts between the magnet unit 51 and the coil unit 50. In this manner, the magnet unit 51 can be propelled along the arrangement direction of the coil members 52.

In the linear motor actuator 1 constructed as described above, when the coil unit 50 is energized and the linear motor actuator 1 is operated, the respective coil members 52 of the coil unit 50 generate heat, and the heat is conducted to the base plate 2 and the table plate 4. Therefore, the temperatures of those plates tend to increase.

Because the coil unit 50 is a heat generation source, when the coil unit 50 is disposed on the base plate 2 as in the above-mentioned embodiment, most heat generated by the coil unit 50 is conducted to the base plate 2. However, the coil unit 50 and the magnet unit 51 are provided close to each other via a gap of several millimeters, and hence when the linear motor actuator 1 is continuously operated at the rated thrust force, the coil unit 50 becomes hot up to about 70 to 90° C. As a result, the magnet unit 51 becomes hot due to a radiation from the coil unit 50 and the air convection, and the table plate 4 to which the magnet unit 51 is fixed also becomes hot.

When the linear motor actuator 1 is continuously operated at the rated thrust force, the temperatures of the base plate 2 and the table plate 4 do not increase unlimitedly. After the temperature increases up to some degree, the thermal equilibrium state is achieved, and the temperature becomes a saturated temperature at which no more temperature increase is observed even when the operation is continued. However, when the base plate 2 and the table plate 4 are compared to each other, a difference is generated in this saturated temperature.

When a difference is generated between the saturated temperatures of the base plate 2 and the table plate 4, because thermal expansion occurs in each of the plates 2 and 4 based on its temperature, a difference is generated between the thermal expansion amounts of the base plate 2 and the table plate 4. As a result, as illustrated in FIG. 3, a difference is generated between a distance LB between the pair of track rails 30 fixed to the base plate 2 and a distance LT between the moving blocks 31 assembled to those track rails 30. In one side surface of the track rail 30, the balls 32 are compressed between the track rail 30 and the moving block 31, and in the other side surface of the track rail 30, a gap is generated between the ball 32 and the track rail 30 or the moving block 31.

For example, in the case where the material for the base plate 2 and the material for the table plate 4 are the same and the saturated temperature of the base plate 2 is higher than that of the table plate 4 during operation, even when the distance LB between the pair of track rails 30 is the same as the distance LT between the moving blocks 31 assembled to those track rails 30 in a state before the operation starts, when the operation starts and each of the temperatures of the base plate 2 and the table plate 4 increases up to the vicinity of the saturated temperature, the distance LB becomes larger than the distance LT. Therefore, in FIG. 3, balls 32a located on the outer surface of the track rail 30 are compressed between the track rail 30 and the moving block 31, and thus the balls 32a are applied with so-called preload.

However, when the difference between the distance LB and the distance LT increases too much, the balls 32a are excessively compressed to the linear guide 3 beyond the appropriate preload range, and impressions are generated on the rolling contact surface 33 of the track rail 30 and the load rolling contact surface of the moving block 31, or uneven wear occurs in the balls 32a. Thus, there is a fear that the life-span of the linear guide 3 becomes short.

In order to avoid such problems, first, it is necessary to select a material having a small coefficient of linear expansion for each of the base plate 2 and the table plate 4. This is because, when the material having a small coefficient of linear expansion is selected, the thermal expansion amount of each of the base plate 2 and the table plate 4 can be suppressed. Specifically, selecting a material having a coefficient of linear expansion of 11×10⁻⁶ (1/° C.) or less is effective.

Examples of the structural material suitable for the base plate 2 or the table plate 4, which has a coefficient of linear expansion of 11×10⁻⁶ (1/° C.) or less, include ceramics and a low thermal expansion cast metal. However, ceramics is troublesome in processing of bolt holes necessary when equipment such as the track rail 30 and the moving block 31 is mounted thereto, and the manufacturing cost increases. Therefore, considering the machining easiness, the latter low thermal expansion cast metal is a preferred choice. As low thermal expansion cast metals available in the market, there are known a low thermal expansion cast metal having a coefficient of linear expansion of about 7.5×10⁻⁶ (1/° C.) (manufactured by Nippon Chuzo Co. Ltd./product name: LEX-75), or another low thermal expansion cast metal having a coefficient of linear expansion of 0.8×10⁻⁶ (1/° C.) or less (manufactured by Nippon Chuzo Co. Ltd./product name: LEX-SF1).

Further, in order to reduce the difference between thermal expansion amounts of the base plate 2 and the table plate 4, setting a difference between the coefficients of linear expansion of the base plate 2 and the table plate 4 is effective. Which coefficient of linear expansion of the base plate 2 or the table plate 4 is set to be smaller differs depending on the high-low relationship of the saturated temperatures of those base plate 2 and table plate 4. When the saturated temperature of the base plate 2 is higher than that of the table plate 4, the coefficient of linear expansion of the base plate 2 is set smaller than that of the table plate 4, and in the reverse situation, the coefficient of linear expansion of the table plate 4 is set smaller than that of the base plate 2.

The coil unit 50 serving as the heat generation source is fixed to the base plate 2, and hence when the base plate 2 and the table plate 4 are compared to each other, the heat energy amount conducted to the base plate 2 is larger than that conducted to the table plate 4. Therefore, when the linear motor actuator 1 is considered as one independent system, the saturated temperature of the base plate 2 becomes higher than that of the table plate 4. In this case, as an example of the coefficients of linear expansion of the base plate 2 and the table plate 4, the coefficient of linear expansion of the base plate 2 is set to 0.8×10⁻⁶ (1/° C.) and the coefficient of linear expansion of the table plate 4 is set to 2.5×10⁻⁶ (1/° C.).

Meanwhile, the base plate 2 is used by being fixed to another mechanical apparatus (hereinafter, referred to as “mounting target member”), and hence when the base plate 2 is heated by the heat generated by the coil unit 50, a temperature gradient is generated between the base plate 2 and the mounting target member, and the heat generated by the coil unit 50 is conducted from the base plate 2 to the mounting target member. Therefore, even when the coil unit 50 is fixed to the base plate 2, excluding a case where the heat conductivity of the base plate 2 is extremely small or a case where a heat insulating layer is provided between the base plate 2 and the mounting target member, the saturated temperature of the table plate 4 tends to be higher than that of the base plate.

In the case where the heat conductivity of the base plate 2 is set extremely small or in the case where the heat insulating layer is provided between the base plate 2 and the mounting target member, the saturated temperature of the base plate 2 may increase up to the vicinity of 100° C., and there is a fear of accidents such as fire or burn injury. In addition, it becomes necessary to use a material having high heat resistance for the member forming the coil unit 50. Therefore, when the linear motor actuator 1 is actually used, cases of setting the heat conductivity of the base plate 2 to be extremely small and providing the heat insulating layer between the base plate 2 and the mounting target member are considered to be special usage examples. Therefore, it is considered that, in most usage examples, even when the coil unit 50 is provided on the base plate 2, the saturated temperature of the base plate 2 is lower than that of the table plate 4.

In view of the points above, when the difference is set between the coefficients of linear expansion of the base plate 2 and the table plate 4, setting the coefficient of linear expansion of the table plate smaller than the coefficient of linear expansion of the base plate on which the coil unit is provided is effective. In this case, as an example of the coefficients of linear expansion of the base plate 2 and the table plate 4, the coefficient of linear expansion of the base plate 2 may be set to 2.5×10⁻⁶ (1/° C.), and the coefficient of linear expansion of the table plate 4 may be set to 0.8×10⁻⁶ (1/° C.).

The linear motor actuator 1 was actually assembled and the linear motor 5 was caused to continuously operate at the rated thrust force. Then, temperatures of the base plate 2, the table plate 4, and the coil unit 50 were measured. As a result, the saturated temperature of the coil unit 50 reached to 75° C., and the saturated temperature of the base plate 2 at that time was about 45° C., and the saturated temperature of the table plate 4 at that time was about 60° C.

Thus, when the materials used for the base plate and the table plate each have a coefficient of linear expansion of 11×10⁻⁶ (1/° C.) or less and the coefficient of linear expansion of the table plate is set smaller than that of the base plate, it is possible to suppress the thermal expansion amounts of the base plate and the table plate to be small, reduce the difference between the thermal expansion amounts of both the plates to about several tens of μm, and prevent excessive preload from acting to the balls of the linear guide. Accordingly, the linear actuator of this embodiment is capable of sufficiently securing moving accuracy and positioning accuracy of the table plate supported by the linear guides, and in addition, maintaining the accuracies over a long period of time.

Note that, the present invention is not limited to the embodiment described above. For example, the present invention is not limited to a uniaxial linear motor actuator as described in the embodiment, and is applicable to an XY table obtained by stacking the uniaxial linear motor actuators in dual stage. Further, when the present invention is applied to the XY table, the present invention may be applied in both of an X axis and a Y axis, or only in one of the X axis and the Y axis.

1. (canceled)

2. (canceled)

3. A linear motor actuator, comprising:
a base plate to be fixed to another mechanical apparatus;
a plurality of linear guides disposed parallel to each other on the base plate;
a table plate, which is supported by the plurality of linear guides and freely reciprocates above the base plate;
a magnet unit provided on the table plate; and
a coil unit provided on the base plate so as to be opposed to the magnet unit to form a linear motor,
wherein each of the plurality of linear guides comprises:
a track rail having a rolling contact surface for a large number of rolling members formed therein along a longitudinal direction thereof; and
a moving block assembled to the track rail via the large number of rolling members to move along the track rail,
wherein the base plate and the table plate are each made of a material having a coefficient of linear expansion of 11×10⁻⁶ (1/° C.) or less, and
wherein the coefficient of linear expansion of the table plate on which the magnet unit is provided is smaller than the coefficient of linear expansion of the base plate on which the coil unit is provided.

4. A linear motor actuator according to claim 3, wherein the base plate is fixed to the another mechanical apparatus without interposing a heat insulating layer therebetween.
